(19) United States
(12) Patent Application Publication
(10) Pub. No.: US 2002/0014218 A1
(43) Pub. Date: Feb. 7, 2002

(54) Multiple cylinder rotary motor and method of operation

(76) Inventor: Kevin R. Beal, Austin, TX (US)

Correspondence Address: Ted D. Lee, Gunn, Lee & Keeling, Suite 1500, 700 N. St. Mary's Street, San Antonio, TX, 78205, US

(21) Appl. No.: 09/955,567

(22) Filed: Sep. 18, 2001

Related U.S. Application Data
(63) Continuation-in-part of application No. 09/501,832, filed on Feb. 10, 2000, now Pat. No. 6,302,079.
(60) Provisional application No. 60/120,060, filed on Feb. 16, 1999.

(51) Int. Cl. F02B 53/00; F02B 53/04; F04C 18/00; F03C 2/00

(52) U.S. Cl. 123/249; 123/235; 418/191

(57) ABSTRACT

The present invention is directed toward a rotary combustion motor and method of operation. The rotary combustion engine has a large rotor and two smaller rotors that intersect therewith to form combustion chambers between the large rotor and the two smaller rotors. Gears control the timing between each of the rotors and give one rotation output. Blocks may be stacked and connected together to give additional output, each block containing a large rotor and two smaller rotors. The small rotors are crescent shaped, stacked, and connected together on each side of the large rotors.

This application is a continuation-in-part of Application Ser. No. 09/501,832, filed on Feb. 10, 2000, which claims the benefit of U.S. Provisional Application No. 60/120,060, filed on Feb. 16, 1999.

### BACKGROUND OF THE INVENTION

1. Field of the Invention

The present invention relates to rotary motors, and more particularly, to an improved multiple cylinder rotary engine including the configuration and arrangement of the rotors. The rotary cylinders may be stacked and the rotors may have multiple blades or chambers per rotor. This provides for smoother operation of the motor.

2. Background Information

Reciprocating engine motors on the market today generally involve pistons which are thrust in one direction as a result of combustion. Generally, where one piston is thrust in an upward direction a second is thrust downward. However, the pistons may rest at non-vertical angles with respect to one another resulting in a more side to side movement. Whatever the case, once a piston reaches a maximum velocity it must come to a complete stop and be forced in the opposite direction. This process repeats over and over again as the engine runs. The fundamental design of a motor with this version of reciprocating parts is inefficient. This version of a reciprocating parts motor involves an inherent defect in that every stroke of a piston requires that it come to a complete stop.

There is a long felt unmet demand for more efficient internal combustion reciprocating parts motors. The use of rotary motors, often referred to as Wankel motors, is known in the prior art in various forms. The Wankel rotary engine was named after Felix Wankel, with his first rotary engine being commercially built in 1954. Various versions of the rotary engine were put in various automobiles, including a Citroen and a Mazda RX7. The rotor would turn within a stator (also called a trochoid), in a motion known as epitrochoid. The shaft would rotate at three times the speed of the rotor. The total number of components was approximately one-tenth of those used in a normal piston-type engine. There was a considerable reduction in weight, improvement in efficiency and reduction in manufacturing cost. However, two primary problems continued to exist for the Wankel rotary engine. First, the rotary tips would wear resulting in high oil and fuel consumption, loss of power and high emissions. Second, it was almost linear torque curve for acceleration, which resulted in the use of torque multipliers, gear boxes and other adaptations at lower engine speeds.

The Wankel rotary engine was not the first rotary-type engine to be developed. In 1588, Agostino Ramelli designed a rotary piston water pump. James Watt obtained several patents on rotary steam engines. By 1910, the British Patent Office had already issued a couple of thousand patents involving rotary-type pumps and engines. Presumably, none of these worked successfully, because none were commercially marketed. Other developments continued in attempts to develop a successful rotary engine.

Of those found, the closest patent to the present invention was issued to Knickerbocker. Knickerbocker, U.S. Pat. No. 3,923,014 discloses a rotary motor utilizing a pair of complimentary rotors in place of a typical piston design. However, Knickerbocker fails to disclose the regulated intake necessary to achieve even a modest level of efficiency. Without a controlled intake mechanism an ignited fuel and air mixture will enter the air supply and significantly decrease its effectiveness. The Knickerbocker design reveals other deficiencies as well. For example, it cannot accommodate dual ignition without substantial modifications.

### SUMMARY OF THE INVENTION

It is an object of the present invention to provide an efficient rotary motor.

It is another object of the present invention to provide a rotary motor utilizing a controlled intake which preserves the pressurization of an adjacent plenum.

It is another object of the present invention to provide a rotary motor capable of efficiently utilizing dual ignition within a single piston assembly.

It is yet another objective of the present invention to provide a rotary motor providing sufficient combustion area in all rotary chambers so as to maximize overall viability of the motor.

It is a further object of the present invention to provide a rotary motor maximizing removal of spent fuel based on positioning of the exhaust.

It is a further object of the present invention to provide a rotary motor having a balanced design with minimal vibration.

It is a further object of the present invention to provide a rotary motor having a high degree of utility as a pump, air conditioning compressor or air compressor.

It is a further object of the present invention to provide a rotary motor designed with efficient means of cooling and oiling, with or without seals.

It is a further object of the present invention to provide a first piston rotary assembly designed to work in conjunction with a second piston rotary assembly to provide a two or four ignition rotary motor.

It is another object of the present invention to provide multiple rotary cylinders for a rotary engine.

It is still another object of the present invention to have multiple blades for each of the rotors, which rotors may be stacked to form multiple cylinders to allow for a smoother operating engine.

It is yet another object of the present invention to provide a uniquely shaped rotor that maximizes the power and efficiency of the engine.

It is another object of the present invention to provide a method of operation for a rotary motor to increase efficiency over the known art.

In satisfaction of these and related objectives, the present invention provides a novel rotary motor with increased efficiency and maximum performance resulting from a particularly designed controlled intake mechanism and dual ignition means. Other features of the motor add to its overall efficiency and performance as disclosed herein.

### BRIEF DESCRIPTION OF THE DRAWINGS

FIG. 1 is a perspective view of an automobile within which the preferred embodiment of the present invention would be best utilized.

FIG. 2 is a cross-section of the automobile illustrating the placement of the preferred embodiment of the present invention.

FIG. 3a depicts the positioning of the valve assembly and motor rotors with respect to one another at a first fixed position for each rotor.

FIG. 3b depicts the positioning of the valve assembly and motor rotors with respect to one another at a position 60° removed from the first fixed position of each rotor.

FIG. 3c depicts the positioning of the valve assembly and motor rotors with respect to one another at a position 120° removed from the first fixed position of each rotor.

FIG. 3d depicts the positioning of the valve assembly and motor rotors with respect to one another at a position 180° removed from the first fixed position of each rotor.

FIG. 3e depicts the positioning of the valve assembly and motor rotors with respect to one another at a position 240° removed from the first fixed position of each rotor.

FIG. 3f depicts the positioning of the valve assembly and motor rotors with respect to one another at a position 300° removed from the first fixed position of each rotor.

FIG. 4 is a front cross-sectional view of the motor detailing air intake, dual combustion and other features.

FIG. 5a is a rear cross-sectional view of the motor detailing linkage between the air intake system and each rotor.

FIG. 5b is a rear cross-sectional view of the motor detailing cooling and oiling features of the motor.

FIG. 6a depicts the large rotor alone detailing its balancing features.

FIG. 6b depicts the small rotor alone detailing its balancing features.

FIG. 7 is a front cross-sectional view of the motor with modified application to a pump.

FIG. 8 is a front cross-sectional view of the motor in dual cylinder form providing a four ignition motor.

FIG. 9 is an illustrative pictorial view of a multiple cylinder rotary engine utilizing the present invention.

FIG. 10 is an illustration of stacked rotary engine cylinders to form a total of six cylinders.

FIG. 11 is a front view of FIG. 10 with the rotors shown in broken lines.

FIG. 12 is an end view of FIG. 10.

### DETAILED DESCRIPTION OF THE PREFERRED EMBODIMENT

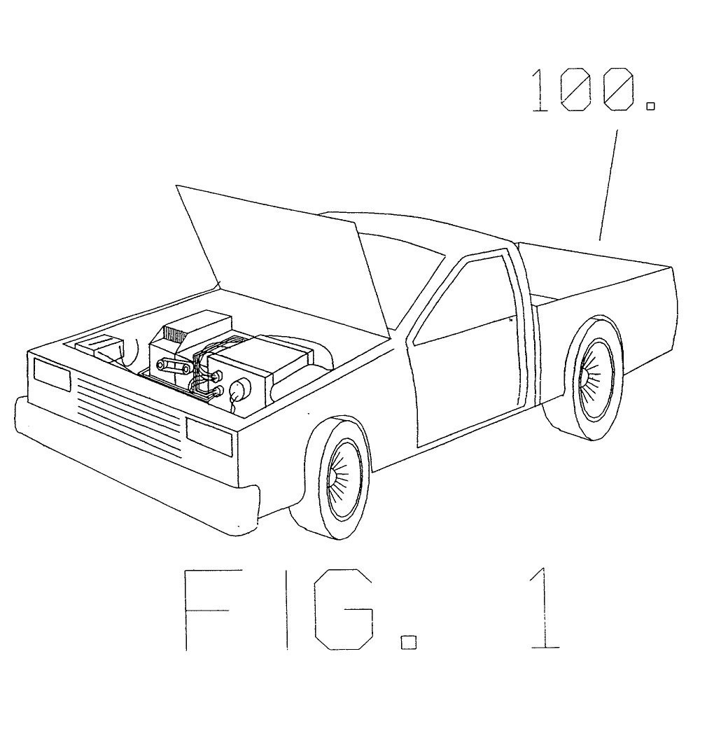

In FIG. 1 an automobile 100 is shown. Such an automobile 100 is one of many types of systems in which the preferred embodiment of the present invention can be utilized.

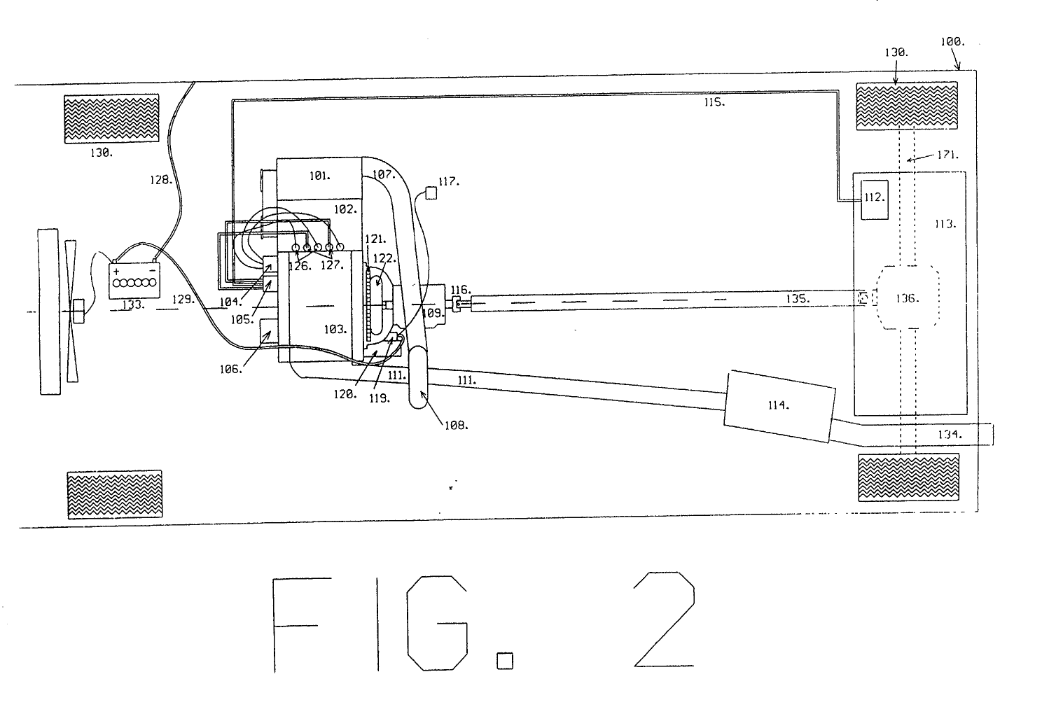

FIG. 2 shows a cross sectional view of the automobile 100 showing the preferred placement of the preferred embodiment of the present invention. Other placements of the invention may be feasible. In order to fully understand the present invention it is important to trace the path of a typical automobile 100 startup. When a person wants to start the automobile 100, he or she will put a key (not shown) into an ignition key switch 117 and turn over the ignition key switch 117 into a start position. The ignition key switch 117 is connected to a starter solenoid 119 within a starter 120 by way of a wire or the like.

When the ignition key switch 117 is switched to the start position, a circuit between a battery 133 and the starter solenoid 1 19 is closed allowing charge to flow from the positive terminal of the battery 133 along a positive battery cable 129 to the starter solenoid 119. The negative terminal of the battery 133 is grounded by an electrical ground wire 128 to the side of the automobile 100.

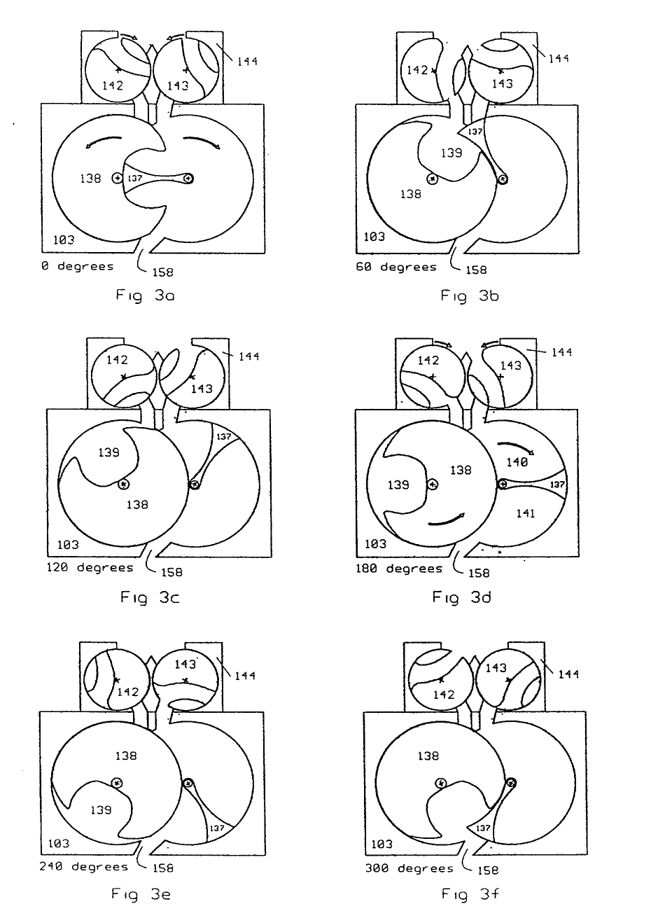

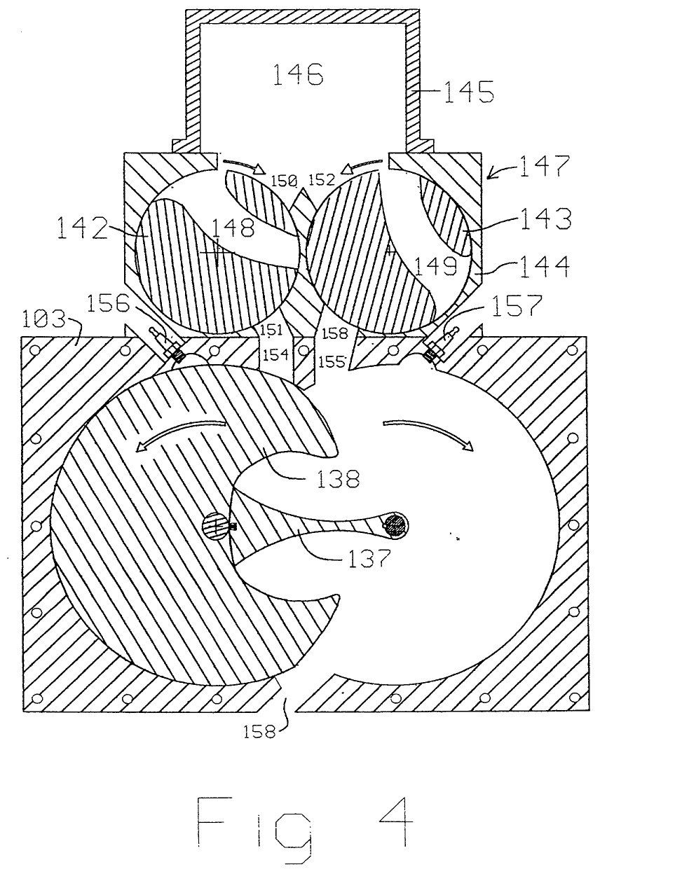

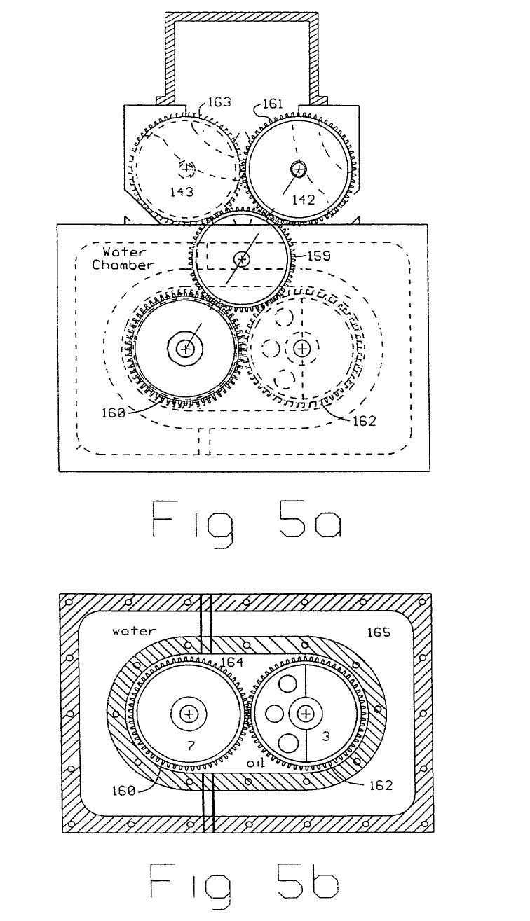

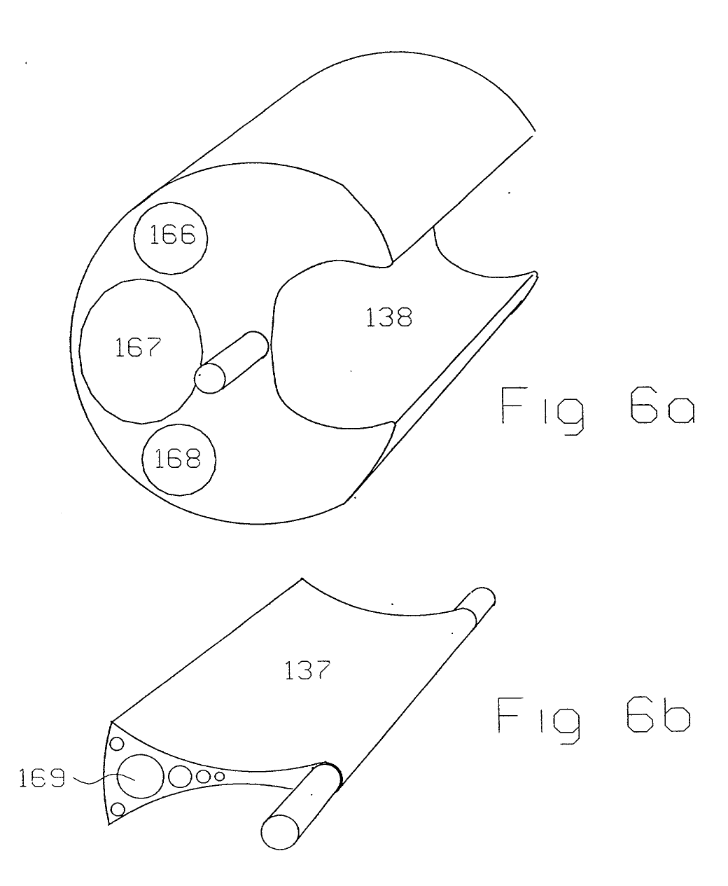

The starter solenoid 119 is an electromagnet when it carries the current and the amount of current flowing through the electromagnet is directly proportionate to its magnetism. The magnetic field of the starter solenoid 119 causes a bendix (not shown) within the starter 120 to begin spinning. Gears on the bendix (not shown) mesh with teeth on a flywheel 121. The flywheel 121 then engages a camshaft (not shown) which starts the cam (not shown) turning. The cam (not shown) engages a piston or small rotor 137 (see FIG. 3a) rotating the small rotor 137 (see FIG. 3a) in a clockwise direction. The small rotor 137 (see FIG. 3a) rotates a large rotor 138 (see FIG. 3a) in a counterclockwise direction by way of a gear assembly (see FIG. 5a and 5b). The rotation of the rotors 137 (see FIG. 3a) and 138 (see FIG. 3a) acts as a combustion chamber to maintain constant mechanical power within the motor block 103. This mechanical power source in turn converts to electrical power in an alternator 106 which maintains the source of electrical current for the present invention. The byproducts of the combustion process pass out through an exhaust port 158 (see FIG. 3a) into the exhaust pipe 111 into the muffler/catalytic converter 114 and out through the exhaust tailpipe 134.

Once the engine is started, an individual driver can set the automobile 100 into a drive mode by accessing the transmission 109. The transmission 109 contains a torque converter 122 which is connected at one end to a drive shaft 135 by way of a drive shaft universal (“u”) joint 116. The other end of the drive shaft 135 is hooked to a differential 136 at the rear end of the automobile 100. The gears at the differential 136 turn the axles 171 which engage the wheels 130.

In FIGS. 3a-3h, a cross sectional view of a small rotor 137, a large rotor 138, and the present invention, the motor block 103, are shown. In FIG. 3a the small rotor 137 and the large rotor 138 are shown at a fixed position relative to one another. Although the rotors abut one another, they do not make contact at any point during a combustion cycle. That is, there is no direct contact between the rotors in FIGS. 3a-3f. The planes of rotation for the small rotor 137 and the large rotor 138 are preferably surrounded by a water jacket.

Referring specifically to FIG. 3d, a smaller first combustion chamber 139 is apparent in contrast to a larger second combustion chamber 140. A closed spent fuel chamber 141 is also apparent at this point.

Beginning with the fixed position of the rotors (shown in FIG. 3a) the small rotor 137 is shown moving in a clockwise direction in a progression, at every 60°, through to FIG. 1f. The large rotor 138 is shown moving in a counterclockwise direction throughout this same progression. This progression represents movement during a combustion cycle.

FIGS. 3a-3f also reveal a first valve 142 and a second valve 143 within a housing 144 which is engaged to the motor block 103. Again, beginning with the fixed position of the valves 142 and 143 (shown in FIG. 3a) the first valve 142 is shown moving in a clockwise direction (at the same rate as the small rotor 137) in a progression, at every 60°, through to FIG. 3f. Again, the second valve 143 is shown moving in a counterclockwise direction (at the same rate as the large rotor 138) throughout this same progression. This represents valve progression during a combustion cycle.

With reference to FIG. 3d, the larger second combustion chamber 140 and spent fuel chamber 141 are shown with an exhaust port 158 trailing therefrom. Again with reference to FIG. 3d, the exhaust port 158 is best positioned near the terminal end of what will constitute the spent fuel chamber 141. This is to encourage maximum evacuation of spent fuel. Additionally, the small rotor 137 and the large rotor 138 are designed to provide maximum volumes within the first combustion chamber 139 and second combustion chambers 140 (as shown in FIG. 3d).

Referring to FIG. 4, a plenum casing 145 and plenum 146 are provided. These are typically found with superchargers 101 (see FIG. 2). The plenum casing 145 seals pressurized air within the plenum 146 allowing its regulated escape only through the valving mechanism 147 provided. The valving mechanism 147 consists of the first valve 142 having a first inlet port 148 and a second valve 143 having a second inlet port 149. The valving mechanism 147 is encased within the housing 144. The housing 144 has a first upper housing port 150 and a first lower housing port 151 which are sealable by the first valve 142. The housing 144 also provides a second upper housing port 152 and a second lower housing port 153 which are sealable by the second valve 143. The lower housing ports 151 and 153 are in continuous alignment with a first block port 154 and a second block port 155. FIG. 4 also discloses a first spark plug 156 and a second spark plug 157. Although spark plugs 156 and 157 are shown, other combustion means may also be used.

In FIG. 4, pressurized air is let in from the plenum 146 and through the first upper housing port 150 and the first inlet port 148 as the first valve 142 moves from the resting position (see FIG. 3a) to at least 30° (not shown). Pressurized air continues through the first inlet port 148 and into the first lower housing port 151 and first block port 154 as the first valve 142 moves beyond 30° and continues until the first valve 142 reaches at least 75°. It is during this stage of rotation (i.e. between 30° and 75°) that a combustible material, fuel, is let into the smaller first combustion chamber 139 behind the first spark plug 156 (see FIG. 3b). The fuel itself originates in the fuel tank 113 (see FIG. 2). The fuel is pumped by a fuel pump 112 (see FIG. 2) into a fuel line 115 (see FIG. 2). The fuel line 115 (see FIG. 2) terminates in a fuel injection distributor 105 (see FIG. 2) which in turn distributes the fuel through fuel injectors 127 (see FIG. 2) into the motor block 103.

Once the valves 142 and 143 and rotors 137 and 138 reach the 75° position a completely closed smaller first combustion chamber 139 has been formed (see for example FIG. 3c). At this point fuel is ignited by the first spark plug 156 powering the rotation of the large rotor 138.

The process is repeated with respect to the second valve 143 and the small rotor 137. That is, pressurized air is let in from the plenum 146 and through the second upper housing port 152 and the second inlet port 149 as the second valve 143 moves from about the 80° position (not shown) to about 120° (see FIG. 3c). Pressurized air continues through the second inlet port 149 and into the second lower housing port 153 and second block port 155 as the second valve 143 moves beyond 120° and continues until the second valve 143 reaches 180°. It is during this stage of rotation (i.e. between 120° and 180°) that fuel is let into the larger second combustion chamber 140 behind the second spark plug 157. Once the valves 142 and 143 and rotors 137 and 138 reach at least the 180° position a completely closed larger second combustion chamber 140 has been formed (see FIG. 3d). At this point fuel is ignited by the second spark plug 157 powering the rotation of the small rotor 137. The ignition propels the small rotor 137 clockwise within the spent fuel chamber 141 and forces the products of combution out the exhaust port 158 as the small rotor 137 approaches its 300° position.

The rotors 137 and 138 and valves 142 and 143 continue on to their start position (as shown in FIG. 3a). The process continues without any stoppage of the rotors 137 and 138 or valves 142 and 143. Any air not taken in by the supercharger 101 (see FIG. 2) passes through turbo high pressure air tubing 107 (see FIG. 2) to an exhaust turbocharger 108 (see FIG. 2).

Referring to FIG. 5a, a rear sectional view of the motor is shown which reveals the gearing between the rotors 137 and 138 (see FIG. 4) (not shown) and the valves 142 and 143. A timing gear 159 is shown which rotates a small rotor gear 160 of the small rotor 137 (see FIG. 4) (not shown) and a first valve gear 161 of the first valve 142 respectively. In this manner, the small rotor 137 (see FIG. 4) and the first valve 142 maintain an equivalent rate of rotation while the motor is running. A large rotor gear 162 of the large rotor 138 (see FIG. 4)) is also shown which is gearably linked to the small rotor gear 160 and maintains an equivalent rate of rotation as to the small rotor 137 and large rotor 138 (see FIG. 4). Likewise, a second valve gear 163 of the second valve 143 is also shown which is gearably linked to the first valve gear 161 and maintains an equivalent rate of rotation as to the first valve 142 and second valves 143. While this is the manner chosen to maintain timing between all rotating parts, other means may be employed. However, the maintenance of timing between an air intake system and the rotors 137 and 138 is important to this embodiment of the invention.

Referring to FIG. 5b, a rear sectional view of the motor is shown which reveals an oil chamber 164 and a water chamber 165. While the particular design chosen for cooling and oiling may vary, this depiction reveals how easily the present invention accommodates cooling and oiling. The motor design allows for the cooling and oiling to occur uniformly around the small rotor 137.

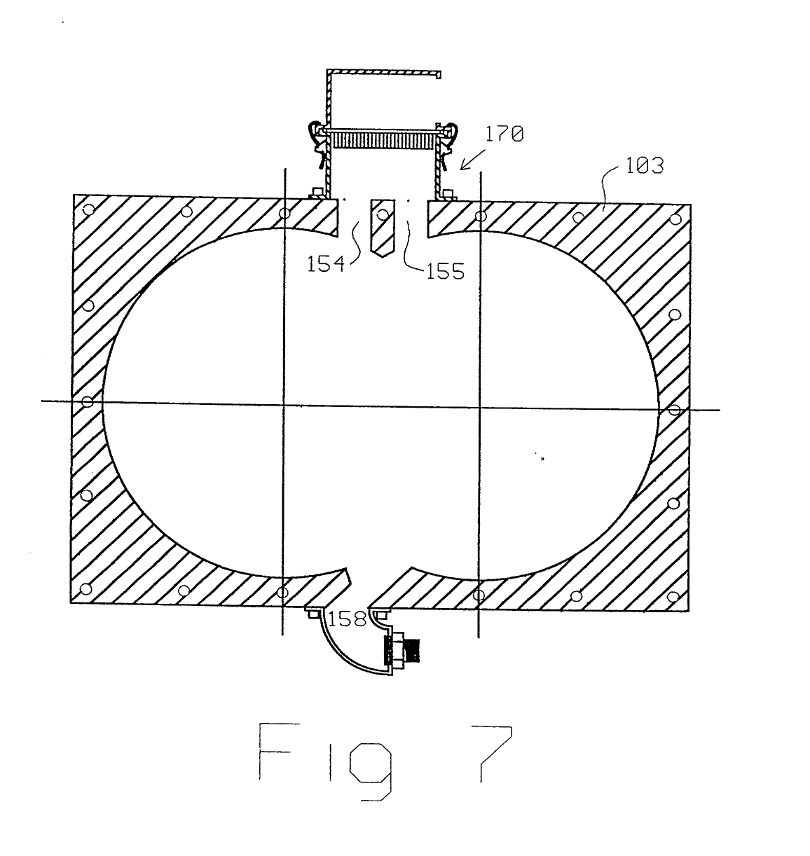

Referring to FIG. 6a and 6b, the large rotor 138 and small rotor 137 are shown independent of the motor block 103. While the precise design of the rotors 137 and 138 may vary, they should be designed with a degree of balance in mind. That is, they should be designed to minimize vibration of the motor block 103 while in use. This may be accomplished with use of hallowed areas 166,167,168, and 169 cored through the length of each rotor 137 and 138. Ideally, larger hallowed areas 166, 167, and 168 would be cored through the length of the large rotor 138.

Referring to FIG. 7, a second embodiment of a pump design of the motor is shown. While this embodiment still incorporates the possibility of dual ignition, the valving mechanism 147 is not provided. The valving mechanism 147 has been replaced with a vacuum control 170. This embodiment of the motor is reflective of the natural vacuum created by the shown design of the rotors 137 and 138. The force of the vacuum is naturally exhibited at the first and second block ports 154 and 155, the intake areas of the motor. Therefore, a vacuum control 170 of various designs could naturally replace the previously disclosed valving mechanism 147 in order to take advantage of this vacuum power. This embodiment specifically removes the controlled intake in order to take advantage of a natural vacuum. While the controlled intake is eliminated, the resulting pump nevertheless has increased efficiency due to the dual ignition and other features previously described herein. Furthermore, the vacuum pump may easily be modified to work as a compressor.

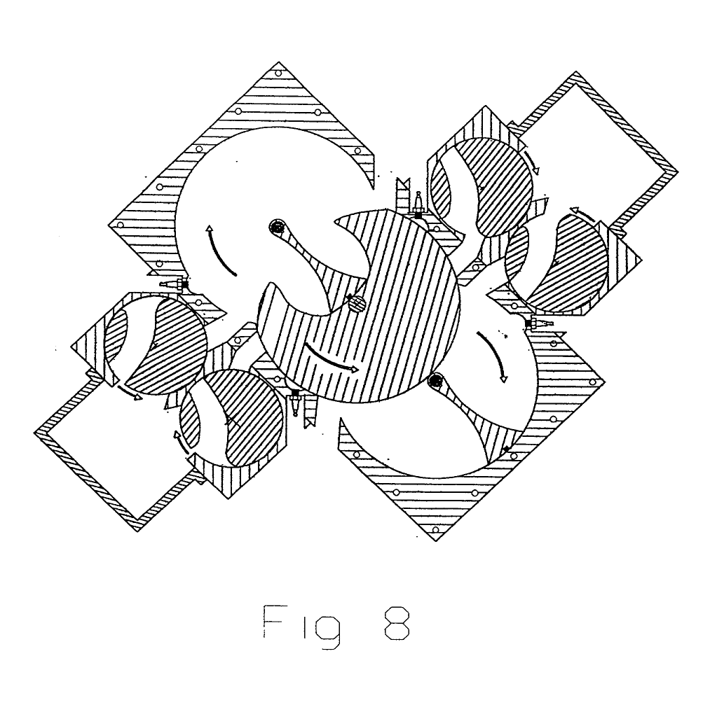

FIG. 8 shows a front cross sectional view of the motor in dual cylinder form providing a four ignition motor.

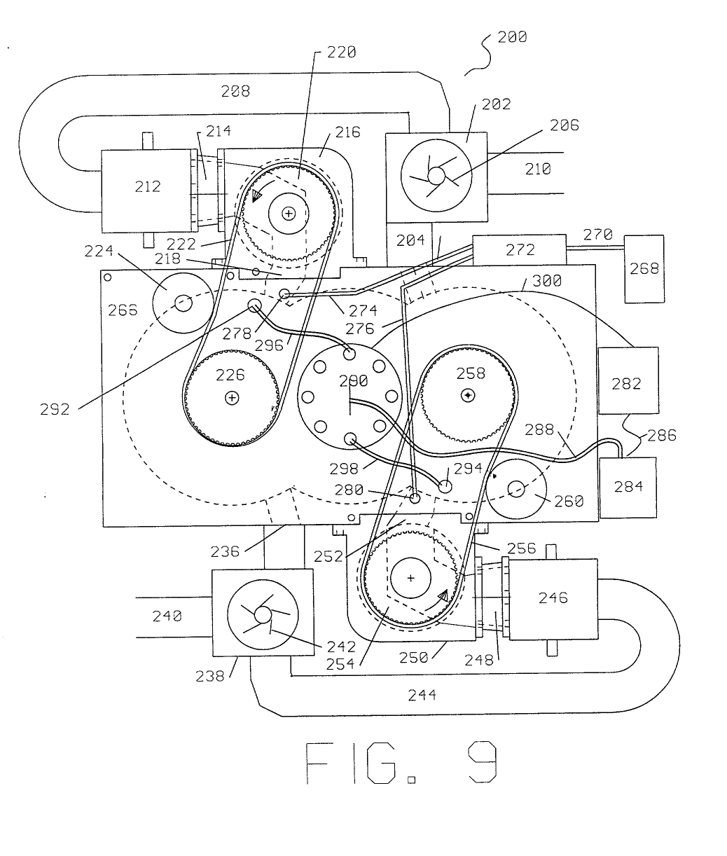

A multiple cylinder rotary engine is shown in FIG. 9 and is represented generally by reference numeral 200. A turbocharger 202 is locate in the exhaust port 204 of the multiple cylinder rotary engine 200. Air is drawn in by the blades 206 of tuborcharger 202 with the air being pressurized inside of the intake manifold 208. While the exhaust gases go through the exhaust port 204 and turbocharger 202 and out exhaust manifold 210, pressurized air flows through the intake manifold 208 into throttle body 212. From the throttle body 212, connector 214 directs the pressurized air through valve body 216 to input port 218. Pulley 220 with the pulley belt 222 controls the sequence of operation the valve (not shown) as contained inside of valve body 216. Idler 224 simply keeps the pulley belt 222 tight.

The opposite end of the pulley belt 222 connects to roller pulley 226, which controls the operation of the rotor (not shown in FIG. 9) inside of the multiple cylinder rotary engine 200. The rotor pulley 226 is connected to the small rotor 228 as can be seen in FIG. 11, which is a cross-sectional view of the block of the multiple cylinder rotary engine 200. The small rotor 228 is a blade in a crescent shape, the sequence of which is timed to be received inside of the pocket 230 of a larger rotor 232. As the small rotor 228 rotates past the input port 218, pressurized fuel air mixture flows into the cylinder 234. By igniting the fuel air mixture inside of the cylinder 234, small rotor 228 will rotate in a counterclockwise direction and the larger rotor 232 will rotate in the clockwise direction. As the small rotor clears exhaust port 236, the burned fuel air mixture will flow from the cylinder 234. From the exhaust port 236, the burned fuel air mixture flows through turbocharger 238 and out the exhaust manifold 240.

The turbocharger 238 in turn draws pressurized air in by the blades 242 for pressurizing air inside of the intake manifold 244 for delivery through the throttle body 246, connector 248 into valve body 250. From the valve body 250, air is directed into the input port 252. A pulley 254 connected by pulley belt 256 connects to rotor pulley 258 of a twin cylinder (see FIG. 11) of the multiple cylinder rotary engine 200. Idler 260 keeps the belt 256 tight.

Referring to FIG. 11, the pressurized fuel air mixture flowing through the input port 252 flows into cylinder 262. A small rotor 264 rotates inside of cylinder 262 and meshes with the pocket 230 of the larger rotor 232. As the small rotor 264 rotates in a counterclockwise direction past input port 252, a pressurized fuel air mixture flows into the cylinder 262. When the pressurized fuel air mixture is ignited, it causes the continued rotation of the small rotor 264, as well as the large rotor 232. As the small rotor 264 rotates past exhaust port 204, the burned fuel air mixture flows out of the exhaust port 204 and into turbocharger 202 (previously described in conjunction with FIG. 9).

Both of the small rotors 228 and 264, as well as the large rotor 232, are combined into a single block 266. Therefore, two cylinders are formed in single block 266 of the multiple cylinder rotary engine 200. The shape of the small rotors 228 and 264 is crescent shape, so that after they pass their respective input ports 218 and 252, and the fuel air mixture is ignited, the maximum power is delivered to the small rotors 228 and 264. The outer tips of the small rotors 228 and 264 rub against the inside surface of the cylinders 234 and 262, respectively, or against the surface of the large rotor 232 as contained inside of the pocket 230. It is important that the outer tip of the small rotors 228 and 264 maintain good contact for maximum efficiency and power.

A fuel pump 268 pumps fuel from the fuel tank (not shown) through fuel line 270 into fuel block 272. From the fuel block 272, fuel is delivered via fuel lines 274 and 276 to injectors 278 and 280, respectively. The fuel is injected through injectors 278 and 280 into the input ports 218 and 252, respectively, of cylinders 234 and 262.

Computer 282 controls the operation of the multiple cylinder rotary engine 200, including operation of the igniter coil 284 through connection 286. From the igniter coil 284, a coil wire 288 goes to the distributor 290. Distributor 290 connects to the spark plugs 292 and 294 via spark plug wires 296 and 298, respectively. Also, computer 282 has various sensor lines 300 for monitoring the operation of the multiple cylinder rotary engine 200. Sensor lines 300 are simply illustrative of the various sensors that will be feeding back to computer 282.

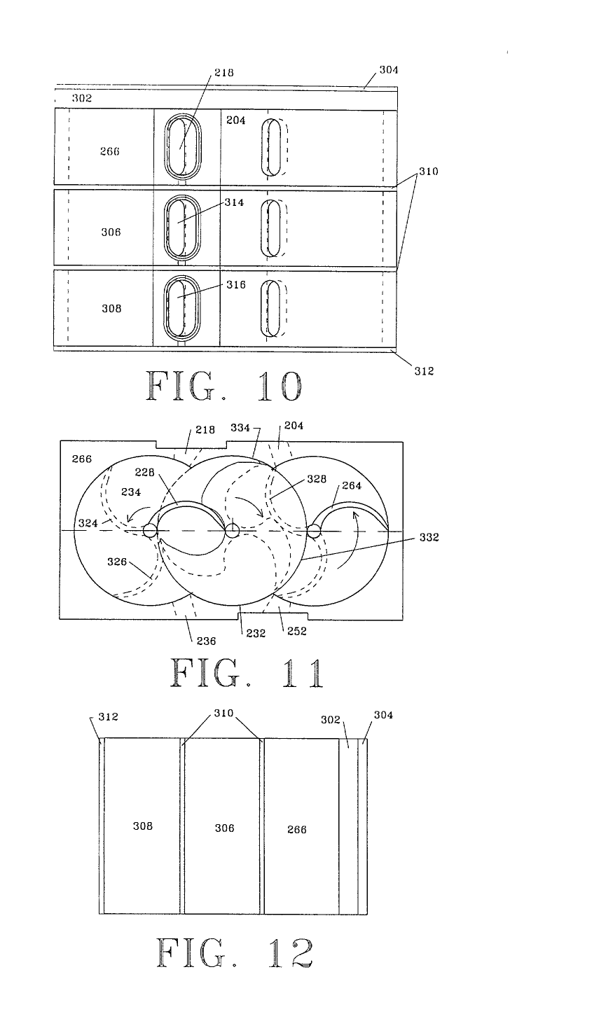

Referring now to FIGS. 10, 11 and 12 in combination, stacked twin cylinders are illustrated in a manner that would be the equivalent of a six cylinder rotary engine. Block 266 with input port 218 and exhaust port 204 is shown. A gear box 302 is connected to one side of block 266 with a gear box cover 304.

Two additional blocks 306 and 308 are connected to block 266 with chamber division plates 310 being located therebetween. A bottom plate 312 may close block 308 or an additional gear box (not shown) may be included. The blocks 306 and 308 have input ports 314 and 316 and exhaust ports 318 and 320, respectively.

Referring now to FIG. 11, the operation of the small rotors 228 and 264 in combination with the large rotor 232 has previously been explained inside of block 266. However, the small rotor 228 that is on the left side of block 266 is physically connected to small rotor 324 located in block 306 and small rotor 326 located in block 308. In other words, small rotors 228, 324 and 326 rotate in unison and are physically one item. By connecting small rotors 228, 324 and 326 together, it is easy to balance the rotor.

Likewise, small rotor 364 on the right side of block 266 is physically connected to small rotors 328 and 330 in blocks 306 and 308, respectively. Again, by the combination of rotors 364, 328 and 330, it is much easier to balance the small rotor. While the large rotor 232 is contained in block 366, similar large rotors 332 and 334 (see broken lines in FIG. 11) are contained in blocks 306 and 308. By combining the large rotors 332 and 334 together, they are much easier to balance. Each of the large rotors defines a pocket 230 with its respective small rotor.

While the operation of the multiple cylinder rotary engine 200 is described in detail in FIG. 9 in operation with the rotary cylinders contained in block 266, the same description would apply to blocks 306 and 308. Likewise, the distributor 290 will be connecting to the spark plugs (not shown) that are contained in blocks 306 and 308. The computer 282 controls the ignition of the spark plugs in each of the cylinders as well as the fuel being injected through the fuel block 272. Each small rotor will have its own turbocharger, such as turbochargers 202 and 238.

The curvature of the small rotors 228, 324, 326, 364, 328 and 332, in combination with the large rotors 232, 332, and 334, is such as to give the maximum efficiency for the combustion of fuel in each of the chambers. The crescent shape of the small rotors is very important. Concerning the large rotor 232, the backside of the rotor may be drilled out to ensure balance of the rotor. It may be necessary to put counterbalances either on or attached to the rotors in much the same way that a tire is balanced for proper operation on an automobile. By use of the three small rotors connected together, the balancing problem is greatly decreased.

Some rotary engines have multiple spark plugs per cylinder for multiple ignitions. This is to ensure a complete burning of the fuel air mixture. Additional spark plugs can be included in the cylinders if it is deemed desirable to ensure a more complete burning of the fuel air mixture.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A rotary motor for an internal combustion engine comprising:
a first motor block;
a large rotor rotatably contained in said first motor block;
a first and second small rotor rotatably contained in said first motor block;
first and second combustion chambers in said first motor block being formed by said first and second small rotor rotatably interacting, respectively, with said large rotor during rotation; and
first and second exhaust ports located downstream of said first and second combustion chambers, respectively.

2. The rotary motor for an internal combustion engine as recited in claim 1 wherein said first and second small rotors are crescent shaped to receive maximum energy during combustion in said first and second combustion chambers, respectively.

3. The rotary motor for an internal combustion engine as recited in claim 1 further includes a turbocharger driven by exhaust gases from said first and second exhaust ports for pressurizing air delivered through first and second inlet ports to said first and second combustion chambers, respectively.

4. The rotary motor for an internal combustion engine as recited in claim 3 further comprising a computer for timing delivery of fuel to said first and second combustion chambers and controlling ignition thereof.

5. The rotary motor for an internal combustion engine as recited in claim 4 further having multiple ignitions in each of said first and second combustion chambers.

6. The rotary motor for an internal combustion engine as recited in claim 1 having additional motor blocks attached to said first motor block, each additional motor block having an additional large rotor and additional first and second small rotors for forming additional first and second combustion chambers, respectively.

7. The rotary motor for an internal combustion engine as recited in claim 6 wherein all of said small rotors on a left side of said large rotor are connected together and all of said small rotors on a right side of said large rotor are connected together.

8. The rotary motor for an internal combustion engine as recited in claim 1 having a second motor block and a third motor block all stacked and connected together with said front motor block, each motor block having like components.

9. The rotary motor for an internal combustion engine as recited in claim 1 having a plurality of motor blocks stacked and connected together with said first motor block, each motor block having like components, output of all motor blocks being combined for a single output.

10. The rotary motor for an internal combustion engine as recited in claim 1, including rotary intake valves.

11. The rotary motor for an internal combustion engine as recited in claim 10 wherein said rotary intake valves are supported on shafts extending from each end of said rotary intake valve.

12. The rotary motor for an internal combustion engine as recited in claim 10 wherein an air passageway through said rotary intake valves is only open once during 360 degrees of rotation.

13. The rotary motor for an internal combustion engine as recited in claim 10 wherein said rotary intake valves are balanced.

14. A method of operation of a rotary motor consisting of the following steps:
spinning a large rotor inside a first motor block;
first rotating a first small rotor in said first motor block in a first plane to intersect with said large rotor to form a first combustion chamber therebetween;
second rotating a second small rotor in said first motor block in said first plane to intersect with said large rotor to form a second combustion chamber therebetween;
first igniting of fuel in said first combustion chamber to increase rotation of said first small rotor and said large rotor;
second igniting of fuel in said second combustion chamber to increase rotation of said second small rotor and said large rotor; and
combining together rotational forces of said first small rotor, said second small rotor and said large rotor to give a combined rotational output.

15. The method of operation of a rotary motor as recited in claim 14 includes injecting fuel and pressurized air via a turbocharger into said first and second combustion chambers prior to said first and second ignition, respectively.

16. The method of operation of a rotary motor as recited in claim 15 further includes additional ignition steps in each of said first and second combustion chambers during one revolution of said first or second small rotor, respectively.

17. The method of operation of a rotary motor as recited in claim 14 wherein multiple motor blocks are connected together with said first motor block, each of said multiple motor blocks having a method of operation similar to steps described hereinabove with all rotational forces in all motor blocks being combined into said combined rotational output.

18. The method of operation of a rotary motor as recited in claim 17 where said first small rotor is connected to all small rotors on a left side of said large rotor, and said second small rotor is connected to all small rotors on a right side of said large rotor.

19. The method of operation of a rotary motor as recited in claim 14 includes the step of balancing said first and second small rotors and said large rotor.

20. The method of operation of a rotary motor as recited in claim 14 wherein said first and second small rotors are crescent shaped.
